(19) United States
(12) Patent Application Publication
(10) Pub. No.: US 2017/0340080 A1
(43) Pub. Date: Nov. 30, 2017

(54) SPORT DISC CARRYING DEVICE

(71) Applicant: Raymond Daniel Wayne DeLuz, Poway, CA (US)

(72) Inventor: Raymond Daniel Wayne DeLuz, Poway, CA (US)

(21) Appl. No.: 15/608,999

(22) Filed: May 30, 2017

Related U.S. Application Data
(60) Provisional application No. 62/343,323, filed on May 31, 2016.

(51) Int. Cl. A45C 13/02; A63B 65/10; A63B 67/06; A63H 33/18

(52) U.S. Cl. CPC A45C 13/02; A63B 67/06; A63B 65/10; B62B 2202/24; B62B 2202/40; A63H 33/18

(57) ABSTRACT

A sport disc carrying device is a carrier for holding glow in the dark sport discs used for playing nighttime “Disc Golf.” The sport discs are formed from a glow in the dark material and the carrier has partitioned slots for holding a plurality of sport discs with the interior surfaces formed from a highly reflective material. Each sport disc slot has a light source for recharging the glow in the dark sport discs. The carrier has a rechargeable battery to enable use where no utility power is available

### CROSS-REFERENCE TO RELATED APPLICATION

The present application is related to and claims priority from prior provisional application Ser. No. 62/343,323, filed May 31, 2016 which application is incorporated herein by reference.

### COPYRIGHT NOTICE

A portion of the disclosure of this patent document contains materials, which, is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of carry bags for sports equipment and more specifically relates to a sport disc carrying device.

### 2. Description of the Related Art

Disc Golf has become a very popular sport, and a new twist to the game is playing in the dark. When using regular discs for playing after dark, it is very difficult to see where the disc lands, and players waste a great deal of time searching for missing discs. It is better to use discs which may be seen easily in the dark, such as lighted, fluorescent or glow-type discs. These types of discs may be charged or recharged by a variety of means. Glow-type discs, for example may be recharged by almost any light source but responds best to ultraviolet lights. When playing at night, there is no accessible source of light to recharge the discs, and players must carry a light source for recharging the discs, such as a flashlight, a black light wand or a camera flash. Using a separate light source to re-charge a disc is time-consuming, cumbersome, and can affect the players' night vision, as their eyes have to readjust constantly from the ambient light to the brighter charging light source. Having to continually stop to recharge a disc diminishes the speed and fun of playing the game. Therefore, a need exists for a specially designed new product, which will eliminate these kinds of problems when playing disc golf in the dark and introduce other sports to the night.

None of the above inventions and patents, taken either singly or in combination, is seen to describe the invention as claimed. Ideally, a carry bags for sports equipment should provide carrying and recharging for glow-in-the-dark sports equipment, and yet, would operate reliably and be manufactured at a modest expense. Thus, a need exists for a reliable sport disc carrying device to avoid the above-mentioned problems.

### BRIEF SUMMARY OF THE INVENTION

In view of the foregoing disadvantages inherent in the known carry bags for sports equipment art, the present invention provides a novel sport disc carrying device. The general purpose of the present invention, which will be described subsequently in greater detail, is to provide carrying and recharging for glow-in-the-dark sports equipment.

The sport disc carrying device may comprise four side walls, a base wall connected to lower edges of the four side walls forming an interior volume, a removable cover pivotally connected to a top edge of one of the four side walls that is adapted to selectively enclose one or more portions of the interior volume, a power source attached to one of the side walls or cover and the base wall, at least one partition wall including two opposite wall surfaces each including a light source thereon adapted to light up a respective portion of the interior volume each of the two opposite wall surfaces faces, and each light source is adapted to be electrically and releasably connected to the power source and the partition wall so that the partition wall is removably placed within the interior volume between two opposite of the four side walls forming at least two sport disc slots.

The four side walls have interior surfaces formed of a reflective material and the light source is formed as at least one light emitting diode. The partition walls are spaced apart forming a plurality of sport disc slots. The removable cover includes a detachable connector upon the edge portion thereof adapted to releasably connect to a detachable connector upon the upper edge portion of one of the four side walls, such that the removable cover is adapted to releasably enclose the interior volume. The detachable connectors may be formed as magnet members, hook and pile connection members, snap members, zipper members or any similarly functional reusable detachable connector.

The power source is preferably formed as a rechargeable battery member. The four side walls, the bottom wall, and the removable cover are preferably formed from a fabric material.

The detachable connectors are respectively electrically connected to the power source and the partition walls such that when the removable cover is in a closed position the detachable connectors connect with one another completing an electrical circuit between the power source and the partition walls thereby energizing and lighting each light source, and when the removable cover is pivoted to an open position the detachable connectors detach from one another breaking the electrical circuit between the power source and the partition walls thereby turning off each the light source. One or more of the spaced partition walls includes a switch thereon adapted to allow a user to turn on or off the light source.

Accessories may be attached to one or more of the side walls, base or cover. A speaker member may be attached to an exterior surface of one of the four side walls and a bottle holder may be attached to the exterior surface of one of the other of the four side walls. A pencil sharpener may also be attached to the exterior surface of one of the four side walls for use in sharpening pencils to keep score. The removable cover may include a handle member attached to an outer surface.

The invention may comprise multiple parts forming a sport disc system having a plurality of sport discs each comprising a body portion formed having a disc-shape of light reactive material that is adapted to glow after being energized by a light source, and a sport disc carrying device comprising four side walls, a base wall connected to lower edges of the four side walls forming an interior volume, a removable cover pivotally connected to a top edge of one of the four side walls that is adapted to selectively enclose the interior volume, a power source attached to one of the four side walls or cover and the base wall, at least one partition wall including two opposite wall surfaces each having a reflective surface thereon adapted to light up a respective portion of the interior volume each of the two opposite wall surface faces.

Each light source is adapted to be electrically and releasably connected to the power source and the partition wall is removably placed within the interior volume between two opposite side walls forming at least two sport disc slots each adapted to releasably retain and energize a respective one of the plurality of sport discs that are placed therein. The four side walls have interior surfaces formed of a reflective material, and the light source is formed as at least one light emitting diode.

One or more of the side walls, base or cover may include a cavity or enclosure for the power source.

One or more of the side walls, base or cover may include a cavity or enclosure for a master on/off switch.

One or more of the partition walls, base or cover may include a cavity or enclosure for an on/off switch for the partition.

One or more of the side walls, base or cover may include a cavity or enclosure for the power source.

In one embodiment, the removable cover includes; a power source, an enclosure for the power source, a master on/off switch, an sealable enclosure for the master on/off switch and a detachable connector upon an edge portion thereof adapted to releasably connect to a detachable connector upon an upper edge portion of one of the four side walls, such that the removable cover is adapted to releasably enclose the interior volume and the detachable connectors are respectively electrically connected to the power source, such that when the removable cover is in a closed position the detachable connectors connect with one another completing an electrical circuit between the power source and the partition wall thereby energizing and lighting each light source, and when the removable cover is pivoted to an open position the detachable connectors detach from one another breaking the electrical circuit and thereby turning off the light source or light sources. The detachable connectors may be formed as magnet members, hook and pile connection members, snap members, zipper members or any similarly functional reusable detachable connector.

The partition walls are spaced forming a plurality of sport disc slots and each may include a switch thereon adapted to allow a user to turn on or off the light source of a selected partition wall.

The present invention holds significant improvements and serves as a sport disc carrying device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention, which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures, which accompany the written portion of this specification illustrate embodiments and method(s) of use for the present invention, sport disc carrying device, constructed and operative according to the teachings of the present invention.

FIG. 1 shows a perspective view illustrating a sport disc carrying device with the removable cover in an open position according to an embodiment of the present invention.

FIG. 2 is a perspective view illustrating the sport disc carrying device with the removable cover in a closed position according to an embodiment of the present invention of FIG. 1.

FIG. 3 is a perspective view illustrating the sport disc system with a sport disc according to an embodiment of the present invention of FIG. 1.

FIG. 4 is a cut-away view illustrating the sport disc system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a carry bags for sports equipment and more particularly to a sport disc carrying device as used to provide carrying and recharging for glow-in-the-dark Disc Golf discs.

Generally speaking, a sport disc carrying device is a carrier for holding glow in the dark sport discs used for playing nighttime “Disc Golf.” The sport discs are formed from a glow in the dark material and the carrier has partitioned slots for holding a plurality of sport discs with the interior surfaces formed from a highly reflective material. A light source formed of at least one light-emitting diode may be located on one or more of the cover, base, side wall, or partition wall. Each sport disc slot has a reflective material or a light source for recharging the glow in the dark sport discs. The carrier has a rechargeable battery to enable use where no utility power is available.

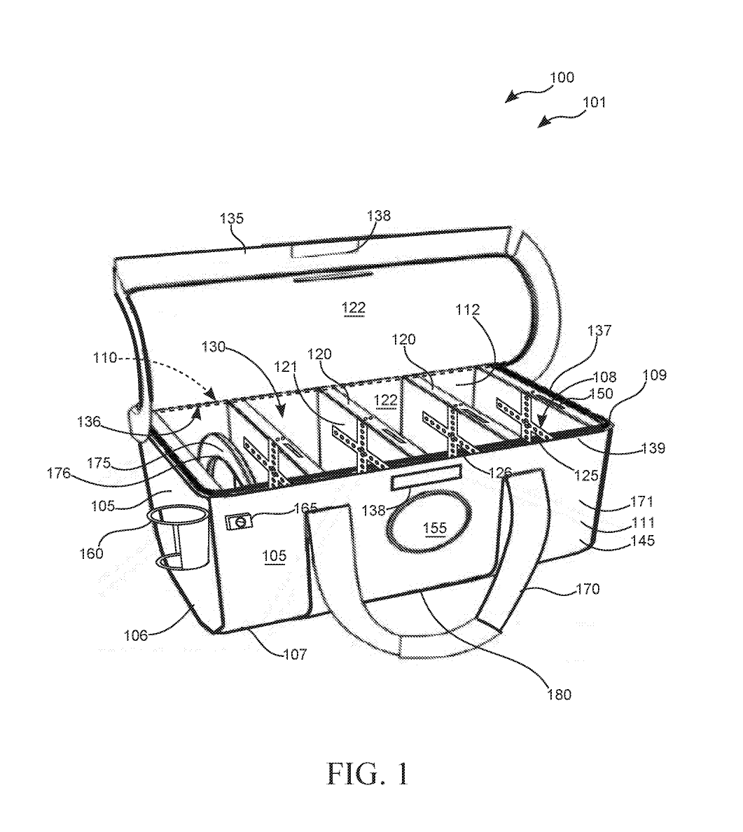

In greater detail now, referring to the drawings by numerals of reference there is shown in FIG. 1, a perspective view illustrating sport disc carrying device 100 with removable cover 135 in an open position according to an embodiment of the present invention.

Sport disc carrying device 100 may comprise four side wall(s) 105, base wall 106 connected to lower edges 107 of the four side wall(s) 105 forming interior volume 108, removable cover 135 pivotally connected to top edge 109 of one of the four side wall(s) 105 that is adapted to selectively enclose interior volume 108, power source 115 attached to one of the four side wall(s) 105 and base wall 106, at least one partition wall 120 including two opposite wall surface(s) 121 each including light source 125 thereon adapted to light up a respective portion of interior volume 108 each of the two opposite wall surface(s) 121, and each light source 125 thereon adapted to light up a respective portion of interior volume or is adapted to be electrically and releasably connected to power source 115 and partition wall 120 so that partition wall 120 is removably placed within interior volume 108 between two opposite of the four side wall(s) 105 forming at least two sport disc slot(s) 130.

The four side wall(s) 105 have interior surface(s) 112 formed of reflective material 122 and light source 125 is formed as at least one light emitting diode 126. Partition wall(s) 120 are spaced apart forming a plurality of sport disc slot(s) 130. Removable cover 135 includes detachable connector 136 upon edge portion 137 thereof adapted to releasably connect to detachable connector 136 upon top edge 109 of one of the four side wall(s) 105, such that removable cover 135 is adapted to releasably enclose interior volume 108.

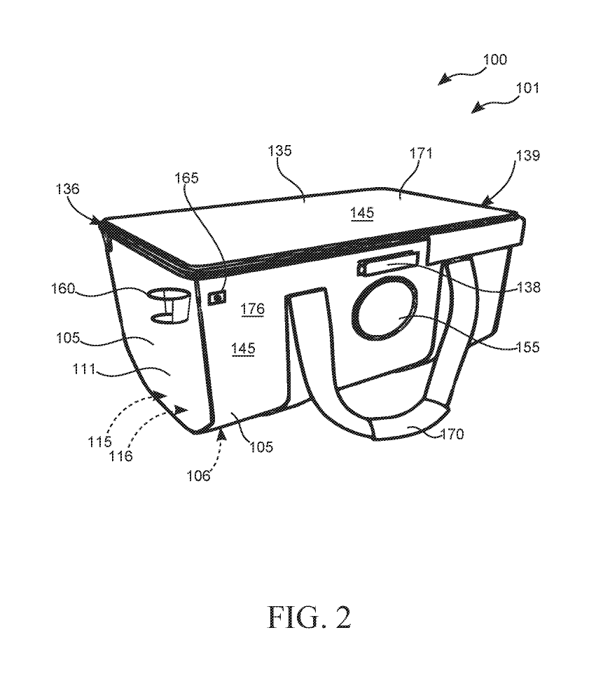

Referring now to FIG. 2, a perspective view illustrating sport disc carrying device 100 with removable cover 135 in a closed position according to an embodiment of the present invention of FIG. 1.

Detachable connectors 136 may be formed as magnet members 138 or they may be formed as zipper members 139. Power source 115 is preferably formed as rechargeable battery member 116. The four side wall(s) 105, base wall 106, and removable cover 135 are preferably formed from fabric material 145.

Detachable connectors 136 are respectively electrically connected to power source 115 and partition wall(s) 120 such that when removable cover 135 is in a closed position detachable connectors 136 connect with one another completing an electrical circuit between power source 115 and partition wall(s) 120 thereby energizing and lighting each light source 125, and when removable cover 135 is pivoted to an open position detachable connectors 136 light source 115 and partition wall(s) 120 thereby turning off each light source 125. Each of the spaced partition wall(s) 120 include switch 150 thereon adapted to allow a user to turn on or off light source 125 for a selected partition wall(s) 120.

Speaker member 155 may be attached to exterior surface 111 of one of the four side wall(s) 105 and bottle holder 160 may be attached to exterior surface 111 of one of the other of the four side wall(s) 105. Pencil sharpener 165 may also be attached to exterior surface 111 of one of the four side wall(s) 105 for use in sharpening pencils to keep score. Removable cover 135 includes handle member 170 attached to outer surface 171.

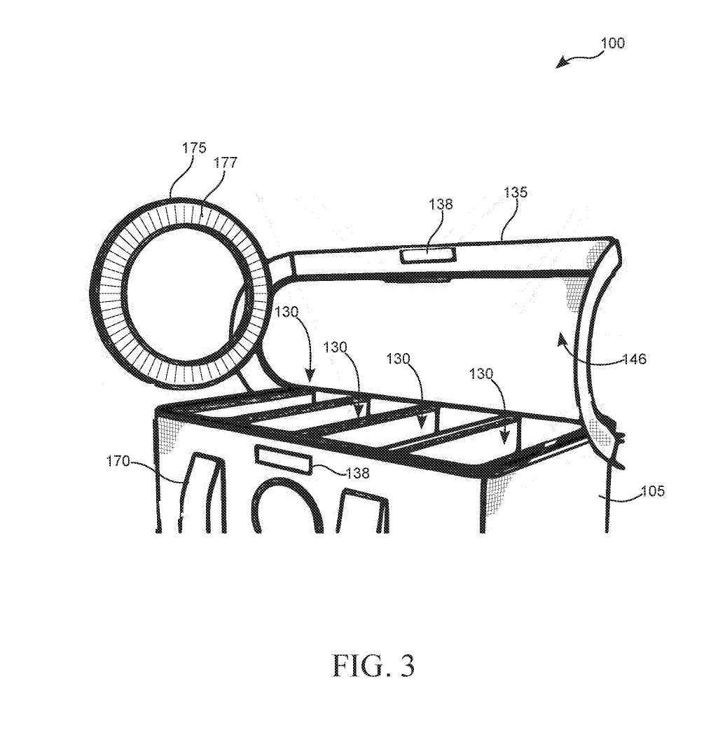

Referring now to FIG. 3, a perspective view illustrating sport disc system 101 with sport disc 175 according to an embodiment of the present invention of FIG. 1.

The invention may comprise multiple parts forming sport disc system 101 having a plurality of sport discs 175 each comprising body portion 176 formed having a disc-shape of light reactive material 177 that is adapted to glow after being energized by light source 125, and sport disc 175 carrying device comprising four side wall(s) 105, base wall 106 connected to lower edges 107 of the four side wall(s) 105 forming interior volume 108, removable cover 135 pivotally connected to top edge 109 of one of the four side wall(s) 105 that is adapted to selectively enclose interior volume 108, power source 115 attached to one of the four side wall(s) 105 and base wall 106, at least one partition wall(s) 120 including two opposite wall surface(s) 121 each having light source 125 thereon adapted to light up a respective portion of interior volume 108 each of the two opposite wall surface(s) 121.

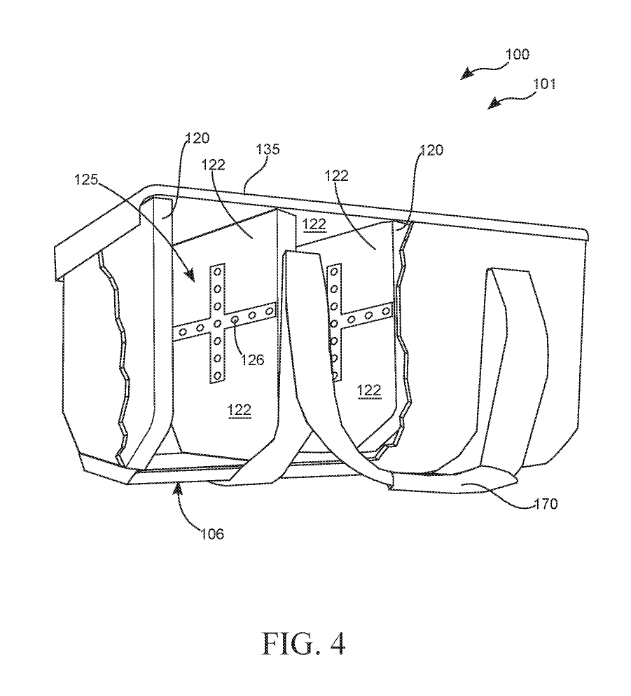

Referring now to FIG. 4, showing a cut-away view illustrating sport disc system 101 according to an embodiment of the present invention of FIG. 1.

Light source 125 is adapted to be electrically and releasably connected to power source 115 and partition wall(s) 120 is removably placed within interior volume 108 between two opposite side wall(s) 105 forming at least two sport disc slot(s) 130 each adapted to releasably retain and energize a respective one of the plurality of sport discs 175 that are placed therein. The four side wall(s) 105 have interior surface(s) 112 formed of reflective material 122, and light source 125 is formed as at least one light emitting diode 126.

Removable cover 135 includes detachable connector 136 upon edge portion 137 thereof adapted to releasably connect to detachable connector 136 upon a top edge 109 of one of the four side wall(s) 105, such that removable cover 135 is adapted to releasably enclose interior volume 108 and detachable connectors 136 are respectively electrically connected to power source 115 and partition wall(s) 120, such that when removable cover 135 is in a closed position detachable connector 136 connect with one another completing an electrical circuit between power source 115 and partition wall(s) 120 thereby energizing and lighting each light source 125, and when removable cover 135 is pivoted to an open position detachable connector 136 detach from one another breaking the electrical circuit between power source 115 and partition wall(s) 120 thereby turning off each light source 125. Detachable connectors 136 may be formed as magnet members 138. Partition wall(s) 120 are spaced forming a plurality of sport disc slot(s) 130 and each may include switch 150 thereon adapted to allow a user to turn on or off light source 125 of a selected partition wall(s) 120.

Sport disc carrying device 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., particular kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A sport disc carrying device comprising:
four side walls;
a base wall;
wherein said base wall is connected to lower edges of said four side walls forming an interior volume;
a removable cover;
wherein said removable cover is pivotally connected to a top edge of one of said four side walls and is adapted to selectively enclose said interior volume;
a power source;
wherein said power source is attached to one of said four side walls and said base wall;
at least one partition wall including:
two opposite wall surfaces each including a light source thereon adapted to light up a respective portion of said interior volume each of said two opposite wall surfaces faces;
wherein each said light source is adapted to be electrically and releasably connected to said power source;
wherein said at least one partition wall is removably placed within said interior volume between two opposite of said four side walls forming at least two sport disc slots.

2. The sport disc carrying device of claim 1, wherein said four side walls have interior surfaces formed of a reflective material.

3. The sport disc carrying device of claim 1, wherein said light source is formed as at least one light emitting diode.

4. The sport disc carrying device of claim 1, wherein said at least one partition wall is formed as a plurality of spaced partition walls forming a plurality of said sport disc slots.

5. The sport disc carrying device of claim 1, wherein said removable cover includes a detachable connector upon an edge portion thereof adapted to releasably connect to a detachable connector upon an upper edge portion of one of said four side walls, such that said removable cover is adapted to releasably enclose said interior volume.

6. The sport disc carrying device of claim 5, wherein said detachable connectors are formed as magnet members.

7. The sport disc carrying device of claim 5, wherein said detachable connectors are formed as zipper members.

8. The sport disc carrying device of claim 1, wherein said power source is formed as a rechargeable battery member.

9. The sport disc carrying device of claim 1, wherein said four side walls, said bottom wall, and said removable cover are formed from a fabric material.

10. The sport disc carrying device of claim 5, wherein said detachable connectors are respectively electrically connected to said power source and said at least one partition wall, such that when said removable cover is in a closed position said detachable connectors connect with one another completing an electrical circuit between said power source and said at least one partition wall thereby energizing and lighting each said light source; and wherein when said removable cover is pivoted to an open position said detachable connectors detach from one another breaking said electrical circuit between said power source and said at least one partition wall thereby turning off each said light source.

11. The sport disc carrying device of claim 4, wherein each of said plurality of spaced partition walls includes a switch thereon adapted to allow a user to turn on or off said light source of selected partition walls.

12. The sport disc carrying device of claim 1, further comprising a speaker member attached to an exterior surface of one of said four side walls.

13. The sport disc carrying device of claim 1, further comprising a bottle holder attached to an exterior surface of one of said four side walls.

14. The sport disc carrying device of claim 1, further comprising an accessories bag attached to an exterior surface of one of said four side walls.

15. The sport disc carrying device of claim 1, wherein said removable cover includes a handle member attached to an outer surface thereof.

16. A sport disc system comprising:
a plurality of sport discs, each comprising:
a body portion formed having a disc-shape;
wherein said body portion is formed from a light reactive material adapted to glow after being energized by a light source; and
a sport disc carrying device comprising:
four side walls;
a base wall;
wherein said base wall is connected to lower edges of said four side walls forming an interior volume;
a removable cover;
wherein said removable cover is pivotally connected to a top edge of one of said four side walls and is adapted to selectively enclose said interior volume;
a power source;
wherein said power source is attached to one of said four side walls and said base wall;
at least one partition wall including:
two opposite wall surfaces each including a light source thereon adapted to light up a respective portion of said interior volume each of said two opposite wall surfaces faces;
wherein each said light source is adapted to be electrically and releasably connected to said power source;
wherein said at least one partition wall is removably placed within said interior volume between two opposite of said four side walls forming at least two sport disc slots each adapted to releasably retain and energize a respective one of said plurality of sport discs therein.

17. The sport disc carrying device of claim 16, wherein said four side walls have interior surfaces formed of a reflective material; and wherein said light source is formed as at least one light emitting diode.

18. The sport disc carrying device of claim 16, wherein said removable cover includes:
a detachable connector upon an edge portion thereof adapted to releasably connect to a detachable connector upon an upper edge portion of one of said four side walls, such that said removable cover is adapted to releasably enclose said interior volume; and
wherein said detachable connectors are respectively electrically connected to said power source and said at least one partition wall, such that when said removable cover is in a closed position said detachable connectors connect with one another completing an electrical circuit between said power source and said at least one partition wall thereby energizing and lighting each said light source; and wherein when said removable cover is pivoted to an open position said detachable connectors detach from one another breaking said electrical circuit between said power source and said at least one partition wall thereby turning off each said light source.

19. The sport disc carrying device of claim 18, wherein said detachable connectors are formed as magnet members.

20. The sport disc carrying device of claim 16, wherein said at least one partition wall is formed as a plurality of spaced partition walls forming a plurality of said sport disc slots; and wherein each of said plurality of spaced partition walls includes a switch thereon adapted to allow a user to turn on or off said light source of selected partition wall.
